(19) United States
(12) Patent Application Publication
(10) Pub. No.: US 2025/0199791 A1
(43) Pub. Date: Jun. 19, 2025

(54) INSTALLATION CHANNEL DETERMINING METHOD, APPARATUS, ELECTRONIC DEVICE, AND STORAGE MEDIUM

(71) Applicants: Beijing Youzhuju Network Technology Co., Ltd., Beijing (CN); Beijing Zitiao Network Technology Co., Ltd., Beijing (CN)

(72) Inventors: Runshan Wang, Beijing (CN); Yuting Bian, Beijing (CN); Xuewu Huang, Beijing (CN); Ye Li, Beijing (CN); Yilei Wang, Beijing (CN); Rina Chang, Beijing (CN)

(21) Appl. No.: 18/985,665

(22) Filed: Dec. 18, 2024

(30) Foreign Application Priority Data
Dec. 19, 2023 (CN) 202311754394.5

(51) Int. Cl. G06F 8/61

(52) U.S. Cl. CPC G06F 8/61

(57) ABSTRACT

Embodiments of the present disclosure provide an installation channel determining method, an apparatus, an electronic device, and a storage medium. The method includes: obtaining a target program package file of a client; determining target status information of a preset functional module set in the target program package file, wherein the preset functional module set contains at least one preset functional module, and the preset functional module set has different status information in program package files used by different installation channels; and determining target installation channel information of the client based on the target status information.

### CROSS-REFERENCE TO RELATED APPLICATION(S)

This application claims priority to Chinese Application No. 202311754394.5 filed in Dec. 19, 2023, the disclosures of which are incorporated herein by reference in their entireties.

### FIELD

Embodiments of the present disclosure relate to the field of computer technologies, and in particular, to an installation channel determining method, an apparatus, an electronic device, and a storage medium.

### SUMMARY

Embodiments of the present disclosure provide an installation channel determining method, an apparatus, an electronic device, and a storage medium.

According to a first aspect, an embodiment of the present disclosure provides an installation channel determining method. The method includes:
obtaining a target program package file of a client;
determining target status information of a preset functional module set in the target program package file, wherein the preset functional module set contains at least one preset functional module, and the preset functional module set has different status information in program package files used by different installation channels; and
determining target installation channel information of the client based on the target status information.

According to a second aspect, an embodiment of the present disclosure further provides an installation channel determining method. The method includes:
receiving target status information sent by a client, wherein the target status information is status information of a preset functional module set in a target program package file of the client, the preset functional module set contains at least one preset functional module, and the preset functional module set has different status information in program package files used by different installation channels; and
retrieving installation channel information corresponding to the target status information from a preset correspondence table, and using the installation channel information as target installation channel information of the client, wherein the preset correspondence table is used to record correspondences between different status information and different installation channel information.

According to a third aspect, an embodiment of the present disclosure further provides an installation channel determining apparatus. The apparatus includes:
a file obtaining module configured to obtain a target program package file of a client;
a status determining module configured to determine target status information of a preset functional module set in the target program package file, wherein the preset functional module set contains at least one preset functional module, and the preset functional module set has different status information in program package files used by different installation channels; and
a first channel determining module configured to determine target installation channel information of the client based on the target status information.

According to a fourth aspect, an embodiment of the present disclosure further provides an installation channel determining apparatus. The apparatus includes:
an information receiving module configured to receive target status information sent by a client, wherein the target status information is status information of a preset functional module set in a target program package file of the client, the preset functional module set contains at least one preset functional module, and the preset functional module set has different status information in program package files used by different installation channels; and
a second channel determining module configured to retrieve installation channel information corresponding to the target status information from a preset correspondence table, and use the installation channel information as target installation channel information of the client, wherein the preset correspondence table is used to record correspondences between different status information and different installation channel information.

According to a fifth aspect, an embodiment of the present disclosure further provides an electronic device. The electronic device includes:
one or more processors; and
a memory configured to store one or more programs,
where the one or more programs, when executed by the one or more processors, cause the one or more processors to implement the installation channel determining method as described in the embodiments of the present disclosure.

According to a sixth aspect, an embodiment of the present disclosure further provides a computer-readable storage medium having a computer program stored thereon, wherein the program, when executed by a processor, causes the installation channel determining method as described in the embodiments of the present disclosure to be implemented.

According to the installation channel determining method, the apparatus, the electronic device, and the storage medium provided in the embodiments of the present disclosure, the target program package file of the client is obtained; the target status information of the preset functional module set in the target program package file is determined, wherein the preset functional module set contains the at least one preset functional module, and the preset functional module set has different status information in the program package files used by different installation channels; and the target installation channel information of the client is determined based on the target status information. Alternatively, the target status information sent by the client is received, wherein the target status information is the status information of the preset functional module set in the target program package file of the client, the preset functional module set contains the at least one preset functional module, and the preset functional module set has different status information in the program package files used by different installation channels; and the installation channel information corresponding to the target status information is retrieved from the preset correspondence table and used as the target installation channel information of the client, wherein the preset correspondence table is used to record the correspondences between different status information and different channel information.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of an installation channel determining method according to an embodiment of the present disclosure;

FIG. 2 is a schematic flowchart of another installation channel determining method according to an embodiment of the present disclosure;

FIG. 3 is a schematic flowchart of yet another installation channel determining method according to an embodiment of the present disclosure;

FIG. 4 is a block diagram of a structure of an installation channel determining apparatus according to an embodiment of the present disclosure;

FIG. 5 is a block diagram of a structure of another installation channel determining apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

Currently, an anti-overwrite file is generally configured, which records information of an application and installation channel number information. The anti-overwrite file is placed in a system partition of a device. Even if the application is upgraded or uninstalled, the anti-overwrite file survives. An installation channel of the application can be determined simply by reading the information in the anti-overwrite file to implement application installation attribution.

However, an implementation of installation attribution in the prior art is demanding in that a system operation permission on the device needs to be obtained. When there is no system operation permission on the device, installation attribution cannot be performed on the application.

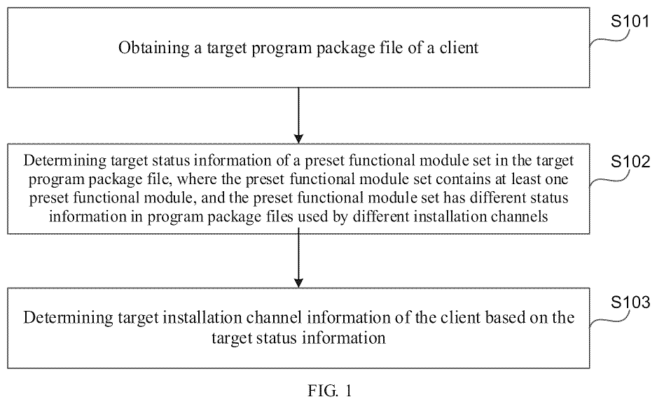

FIG. 1 is a schematic flowchart of an installation channel determining method according to an embodiment of the present disclosure. The method may be performed by an installation channel determining apparatus. The apparatus may be implemented by software and/or hardware, and may be configured in an electronic device. Typically, the apparatus may be configured in a mobile phone, a tablet computer, or a computer. For example, the apparatus may be configured in a client installed on the electronic device or in a server. The installation channel determining method provided in this embodiment of the present disclosure is suitable for a scenario of performing installation attribution on an application.

In brief, application installation attribution may refer to determining installation channel information of the application, and can provide an effect of an application advertisement to an application provider. The application advertisement here is an advertisement in a broad sense, which may include a variety of media channels, such as advertising and pre-installation.

Regarding the application advertisement, a user has two interactive behaviors: viewing the application advertisement and clicking on the application advertisement. Attribution results may be divided into two types: non-organic traffic and organic traffic. The non-organic traffic may mean that the user has interacted with a media channel (usually by displaying or clicking). The organic traffic may mean that the user does not interact with a media channel.

Installation attribution can greatly promote the optimization of application acquisition and activation, and improve the optimization effect. The accuracy of installation attribution has a great impact on the application provider.

Taking a pre-installation scenario as an example, pre-installation refers to pre-installing an application on a device to be shipped from a manufacturer or operator so that a user who purchases the device can use the application. Pre-installation attribution is an important part of pre-installation. The application provider needs to accurately identify which channel the application installation comes from to further analyze the effect of pre-installation. For a pre-installed application, there are usually three scenarios when the user activates the application: the user directly activates a pre-installed version of the application; the application is silently upgraded by an application store of the device, and the user activates a latest version of the application upgraded by the application store; and the user uninstalls the pre-installed version of the application and then downloads a new version of the application from the application store.

For the first scenario, an installation source of the application can be accurately identified by adding some identifiers to the pre-installed version of the application. For the second scenario and the third scenario, since an installation program package of the application has changed, an anti-overwrite capability is required, that is, the installation source of the application can still be accurately identified after the application is upgraded or uninstalled and reinstalled.

Currently, application installation attribution needs to be implemented by using a third-party software development kit (SDK) such as AppsFlyer. A common anti-overwrite method for attribution is to prepare an anti-overwrite file, which records information of the application (such as an application program package name) and channel number (media_source) information. The device manufacturer or the operator places the anti-overwrite file in a system partition of the device. Even if the application is upgraded or uninstalled, the anti-overwrite file survives. When the application is started for the first time, it is only necessary to read the information in the anti-overwrite file.

However, this current method also has the following shortcomings: Placing the anti-overwrite file requires an operation on a system of a mobile phone, requiring a partner (for example, the device manufacturer or the operator) to have a system-level operation capability, but some operator partners cannot operate the system. The partner is prone to an error when placing the anti-overwrite file, and as a result, a device that has not been deployed also carries the anti-overwrite file, leading to an attribution error and a settlement loss. The solution relies on the third-party SDK for implementation, which does not allow for effective attribution control, and also poses a risk of leakage in the data transmission process.

Therefore, this embodiment of the present disclosure provides a new installation attribution solution to reduce the difficulty in application installation attribution and solve at least some of the above technical problems in the prior art.

As shown in FIG. 1, the installation channel determining method provided in this embodiment may include the following steps.

S101: Obtain a target program package file of a client.

The client may be understood as an application whose installation channel information is currently to be determined. The target program package file may be a program package file of the client, such as an application file and/or installation program package of the client.

In this embodiment, the program package file of the client may be obtained, for example, the program package file of the client is obtained from a device on which the client is installed, so that installation channel information of the client is subsequently determined based on the program package file.

S102: Determine target status information of a preset functional module set in the target program package file, wherein the preset functional module set contains at least one preset functional module, and the preset functional module set has different status information in program package files used by different installation channels.

The preset functional module set may be a set of the preset functional module. The preset functional module set may include one or more preset functional modules. A number of the preset functional modules contained in the preset functional module set may be determined based on the number of the installation channels, as long as each present installation channel can be indicated.

The preset functional module may be a functional module in the program package file of the application for determining the installation channel of the application. The preset functional modules contained in the program package files for different installation channels are not exactly the same. For example, a program package file for an installation channel may not contain a preset functional module, and a program package file for another installation channel other than the installation channel may contain at least one preset functional module. There is at least one different preset functional module among the at least one functional module contained in program package files for different installation channels, so that a corresponding installation channel is indicated based on status information of the preset functional module.

The preset functional module may be configured in the program package file in a form of a functional module. Therefore, the preset functional module will not be removed due to an update of the application (such as an update of the program package file), avoiding a case where an installation channel of the application cannot be determined or is mistakenly determined. Optionally, the preset functional module is configured to be updated along with updating of a basic module in the program package file. For example, a version of the preset functional module may be consistent with a version of the basic module in the program package file. When the application store updates the application automatically or based on a trigger operation of the user, the basic module in the program package file may be updated, and the preset functional module in the program package file may be further updated to have a same version number as the updated basic module.

The basic module in the program package file may be a module used to implement a basic function of the application. The basic module may be contained in the program package files used by different installation channels. The preset functional module in the program package file may be an additional module in the program package file. The additional module in the program package file may include but is not limited to the preset functional module. For example, the program package file may further contain a functional module configured to implement another function other than determining the installation channel.

Optionally, the program package file is an Android app bundle (AAB) file, the basic module is a base module in the AAB file, and the preset functional module is a dynamic feature module in the AAB file. The Android app bundle (AAB) file is composed of the base module and a plurality of dynamic feature (DF) modules. The preset functional module may be configured as a DF module in the AAB file. The application store may dynamically distribute DF modules based on an application configuration. Each DF module is independent, and may generate a separate Android application program package (APK) file in another format. A version number of the DF module is the same as that of the base module.

Therefore, when the application is updated, it is ensured that version numbers of all the DF modules are consistent with that of the base module. Even if a DF module of an earlier version before update does not satisfy a distribution condition of the application store, the application store may forcibly update the DF module rather than remove the DF module. Therefore, status information of the DF module (including the preset functional module) in the application program package remains unchanged before and after update. For example, if the application program package before update does not contain any preset functional module, an updated application program package would still not contain the any preset functional module; and if the application program package before update contains one or more preset functional modules, an updated application program package would still contain the one or more preset functional modules, and a specific preset functional module contained in the updated application program package does not change, except that a version of the preset functional module is updated. On this basis, the installation channel of the application can be determined based on the status information of the preset functional module.

The target status information may be status information of the preset functional module set in the target program package file. For example, the status information may be used to indicate whether the target program package file contains the preset functional module in the preset functional module set and/or which preset functional modules in the preset functional module set are contained in the target program package file. Optionally, the target status information is used to indicate whether the target program package file contains the preset functional module. For example, for each preset functional module in the preset functional module set, the target status information may be used to indicate whether the target program package file contains the preset functional module.

Specifically, after the target program package file of the client is obtained, the target status information of the preset functional module set in the target program package file may be determined, for example, the preset functional module contained in the target program package file is determined, and the target status information of the preset functional module set in the target program package file is obtained based on a determination result.

S103: Determine target installation channel information of the client based on the target status information.

The target installation channel information may be understood as installation channel information of the client. The installation channel information may be installation channel related information, such as an installation channel name and/or channel number.

Specifically, after the target status information of the preset functional module set in the target program package file is determined, installation channel information (i.e., the target installation channel information) of the client can be determined based on the target status information.

For example, program package files for different installation channels may contain different preset functional modules. In other words, different preset functional modules correspond to different installation channels. Therefore, the preset functional module contained in the target program package file may be determined based on the target status information, and installation channel information of an installation channel corresponding to the preset functional module is determined as the target installation channel information of the client.

For another example, status information of preset functional modules contained in program package files for different installation channels may not be exactly the same. For example, the program package files for the different installation channels may contain combinations of different preset functional modules. Therefore, the installation channel information of the installation channel corresponding to the target status information can be determined as the target installation channel information of the client.

The installation channel determining method provided in this embodiment may be executed by the client (i.e., the application whose installation channel information is to be determined), and/or the server.

In some implementations, the client may obtain its own target program package file, and determine the target status information of the preset functional module set in the target program package file. The client may determine the target installation channel information of the client based on the target status information. Alternatively, the server determines the target installation channel information of the client based on the target status information.

In this case, optionally, determining target installation channel information of the client based on the target status information includes: retrieving installation channel information corresponding to the target status information from a preset correspondence table, using the installation channel information as the target installation channel information of the client, and sending the target installation channel information to the server, wherein the preset correspondence table is used to record correspondences between different status information and different installation channel information; or, sending the target status information to the server, wherein the sent target status information is used by the server to determine the target installation channel information of the client.

The preset correspondence table may be a table used to record a correspondence between status information and installation channel information. For example, the preset correspondence table may record installation channel information corresponding to each piece of status information of the preset functional module set, and may be preconfigured and stored in the client and/or the server.

For example, after determining the target status information, the client may retrieve and determine, from the preset correspondence table, the installation channel information that corresponds to the target status information and that is recorded in the preset correspondence table, use the installation channel information as its own target installation channel information, and report the target installation channel information to the server.

For another example, the client may send the target status information to the server after determining the target status information, and the server determines the target installation channel information of the client based on the target status information.

In some implementations, the server may obtain the target program package file of the client whose installation channel information is to be determined, determine the target status information of the preset functional module set in the target program package file, and determine the target installation channel information of the client based on the target status information.

According to the installation channel determining method provided in this embodiment, the target program package file of the client is obtained; the target status information of the preset functional module set in the target program package file is determined, wherein the preset functional module set contains the at least one preset functional module, and the preset functional module set has different status information in the program package files used by different installation channels; and the target installation channel information of the client is determined based on the target status information. According to the technical solution in this embodiment, the installation channel of the application is indicated by the preset functional module, without obtaining a system operation permission on the device or using a third-party tool, so that the difficulty in determining the installation channel of the application can be reduced, and accuracy and controllability of a result of determining the installation channel of the application and security in a process of determining the installation channel of the application can be improved.

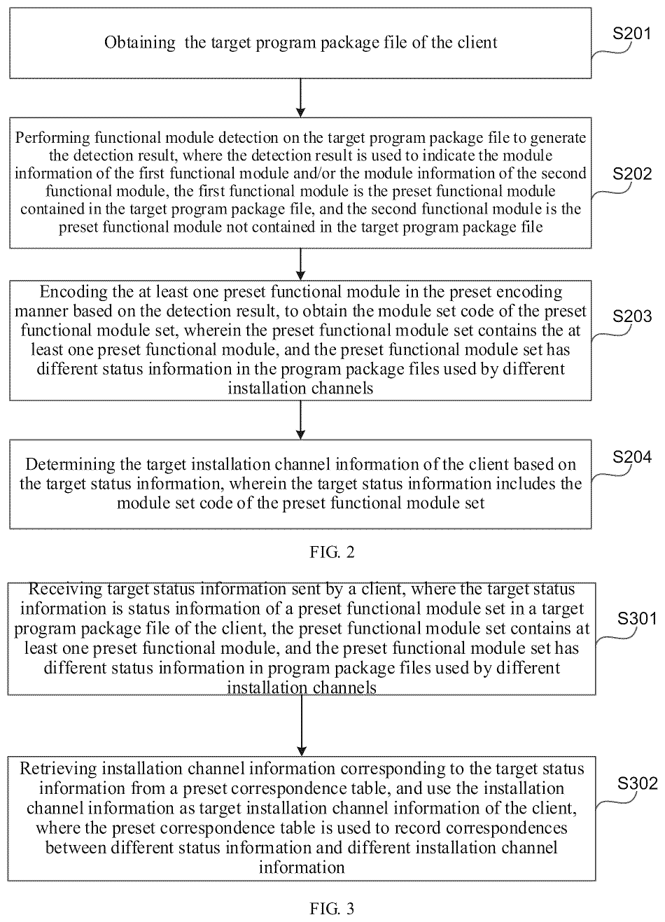

FIG. 2 is a schematic flowchart of another installation channel determining method according to an embodiment of the present disclosure. The solution in this embodiment may be combined with one or more optional solutions in the above embodiment. Optionally, the target status information includes module set code of the preset functional module set, and the determining target status information of the preset functional module set in the target program package file includes: performing functional module detection on the target program package file to generate a detection result, wherein the detection result is used to indicate module information of a first functional module and/or module information of a second functional module, the first functional module is a preset functional module contained in the target program package file, and the second functional module is a preset functional module not contained in the target program package file; and encoding the at least one preset functional module in a preset encoding manner based on the detection result to obtain the module set code of the preset functional module set.

Accordingly, as shown in FIG. 2, the installation channel determining method provided in this embodiment may include the following steps.

S201: Obtain the target program package file of the client.

S202: Perform functional module detection on the target program package file to generate the detection result, wherein the detection result is used to indicate the module information of the first functional module and/or the module information of the second functional module, the first functional module is the preset functional module contained in the target program package file, and the second functional module is the preset functional module not contained in the target program package file.

In this embodiment, after the target program package file is obtained, functional module detection may be performed on the target program package file to generate the detection result.

For example, the preset functional module contained in the target program package file may be used as the first functional module, and the preset functional module in the preset functional module set but not contained in the target program package file may be used as the second functional module. Alternatively, for each preset functional module in the preset functional module set, it may be detected whether the target program package file contains the preset functional module, and if the target program package file contains the preset functional module, the preset functional module is used as the first functional module, or if the target program package file does not contain the preset functional module, the preset functional module is used as the second functional module.

S203: Encode the at least one preset functional module in the preset encoding manner based on the detection result to obtain the module set code of the preset functional module set, wherein the preset functional module set contains the at least one preset functional module, and the preset functional module set has different status information in the program package files used by different installation channels.

The module set code of the preset functional module set may be understood as a set code of the preset functional module set that is obtained based on the target program package file. The module set code of the preset functional module set may be obtained by combining, according to a preset arrangement order, the status code corresponding to each preset functional module contained in the preset functional module set. The preset functional modules contained in the target program package file and the preset functional modules not contained in the target program package file may correspond to different status codes. The preset encoding manner may be an encoding manner set in advance, and the preset encoding manner is not limited. Optionally, the preset encoding manner includes a binary encoding manner to reduce the number of preset functional modules that need to be set.

Specifically, after the detection result is generated, each preset functional module contained in the preset functional module set may be encoded in the preset encoding manner based on the detection result. For example, the first functional module and the second functional module in the preset functional module set are encoded by using different status codes to obtain the module set code composed of the status codes corresponding to the preset functional modules in the preset functional module set.

In some implementations, the encoding at least one preset functional module in a preset encoding manner based on the detection result to obtain a module set code of the preset functional module set includes: determining a status code of the first functional module as a first status code corresponding to the preset encoding manner, and determining a status code of the second functional module as a second status code corresponding to the preset encoding manner; arranging the status code of the at least one preset functional module according to a preset arrangement order corresponding to the preset encoding manner; and combining the arranged status code into one code as the module set code of the preset functional module set.

The first status code may be understood as a status code corresponding to a functional module contained in the program package file in the preset encoding manner. The second status code may be understood as a status code corresponding to a functional module not contained in the program package file in the preset encoding manner. The first status code and the second status code may be different status codes. For example, the first status code and the second status code may be different numbers or letters, etc. As an example, when the preset encoding manner is a binary encoding manner, the first status code may be the number 1, and the second status code may be the number 0; alternatively, the first status code may be the number 0, and the second status code may be the number 1. The preset arrangement order may be a preset arrangement order of the status codes of different preset functional modules when constituting the module set code, and can be flexibly set as required.

For example, after the first functional module and the second functional module in the preset functional module set are determined, the status code of the first functional module may be determined as the first status code in the preset encoding manner, and the status code of the second functional module may be determined as the second status code in the preset encoding manner. A status code of each first functional module and a status code of each second functional module are arranged according to the preset arrangement order indicated in the preset encoding manner, and the status codes arranged are combined into one code as the module set code of the preset functional module set.

Taking a pre-installation scenario as an example, it is assumed that a program package file used by the application store does not contain a df_attribution module (that is, the preset functional module), a program package file used by an installation channel other than the application store contains at least one df_attribution module. Therefore, in a scenario in which a pre-installed application is updated, the presence of the df_attribution module may be detected before and after update; while in a scenario of reinstallation after uninstallation, the program package file of the application does not contain the df_attribution module. Therefore, an installation source of the application may be determined by determining the presence of the df_attribution module.

For example, different pre-installation attributions may be managed in a binary encoding format through permutation and combination of df_attribution modules. For example, a total of six preset functional modules df_attribution_1 to df_attribution_6 may be created. A preset functional module present in the program package file of the application is labeled as 1, and a preset functional module not present in the program package file of the application is labeled as 0. In this way, a six-bit binary number (that is, the module set code) is constructed. As a result, 64 pieces of different pre-installation attribution information (i.e., the installation channel information) can be represented with the six preset functional modules, that is, attribution of a plurality of installation channels can be achieved with only a relatively small number of preset functional modules.

S204: Determine the target installation channel information of the client based on the target status information, wherein the target status information includes the module set code of the preset functional module set.

For example, after the module set code of the preset functional module set is determined, the target installation channel information of the client may be determined based on the module set code. For example, installation channel information that corresponds to the determined module set code and that is in the preset correspondence table is determined as the target installation channel information of the client.

According to the installation channel determining method provided in this embodiment, the module set code of the preset functional module set is generated based on whether the program package file of the client contains the preset functional modules in the preset functional module set, and the installation channel information of the client is determined based on the module set code of the preset functional module set. Therefore, calculations required in the installation channel determining process can be further reduced.

FIG. 3 is a schematic flowchart of an installation channel determining method according to an embodiment of the present disclosure. The method may be performed by an installation channel determining apparatus. The apparatus may be implemented by software and/or hardware, and may be configured in an electronic device. Typically, the apparatus may be configured in a computer. For example, the apparatus may be configured in a server. The installation channel determining method provided in this embodiment of the present disclosure is suitable for a scenario of performing installation attribution on an application. As shown in FIG. 3, the installation channel determining method provided in this embodiment may include the following steps.

S301: Receive target status information sent by a client, wherein the target status information is status information of a preset functional module set in a target program package file of the client, the preset functional module set contains at least one preset functional module, and the preset functional module set has different status information in program package files used by different installation channels.

For example, after the target status information of the preset functional module set in the target program package file is determined, the client whose installation channel information is to be determined may send the target status information to the server. Therefore, the server can receive the target status information sent by the client.

S302: Retrieve installation channel information corresponding to the target status information from a preset correspondence table, and use the installation channel information as target installation channel information of the client, wherein the preset correspondence table is used to record correspondences between different status information and different installation channel information.

For example, after receiving the target status information sent by the client, the server may retrieve and determine, from the preset correspondence table, the installation channel information that corresponds to the target status information and that is recorded in the preset correspondence table, and use the installation channel information as the target installation channel information of the client.

According to the installation channel determining method provided in this embodiment, the target status information sent by the client is received, wherein the target status information is the status information of the preset functional module set in the target program package file of the client, the preset functional module set contains the at least one preset functional module, and the preset functional module set has different status information in the program package files used by different installation channels; and the installation channel information corresponding to the target status information is retrieved from the preset correspondence table and used as the target installation channel information of the client, wherein the preset correspondence table is used to record correspondences between different status information and different channel information. According to the technical solution in this embodiment, the installation channel of the application is indicated by the preset functional module, without obtaining a system operation permission on the device or using a third-party tool, so that the difficulty in determining the installation channel of the application can be reduced, and accuracy and controllability of a result of determining the installation channel of the application, and security in a process of determining the installation channel of the application can be improved.

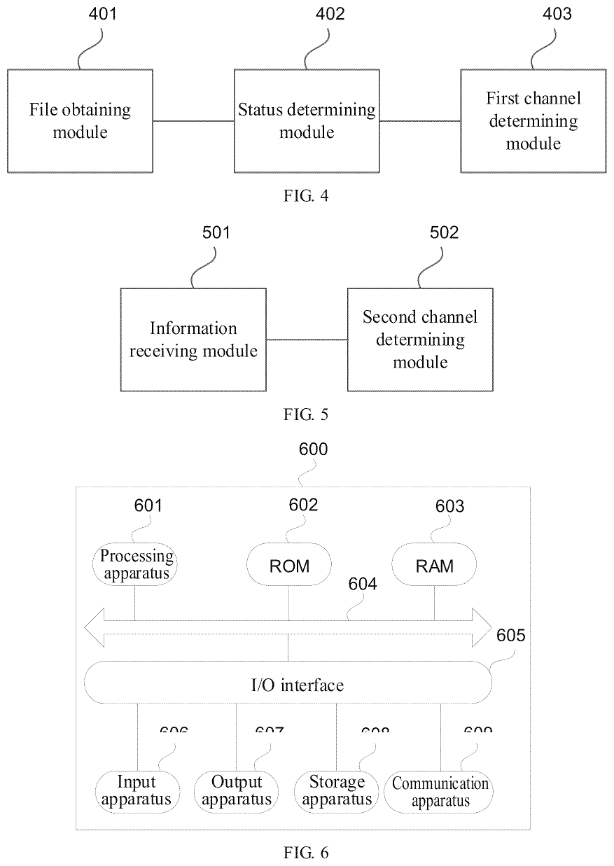

FIG. 4 is a block diagram of a structure of an installation channel determining apparatus according to an embodiment of the present disclosure. The apparatus may be implemented by software and/or hardware, and may be configured in an electronic device. Typically, the apparatus may be configured in a mobile phone, a tablet computer, or a computer. For example, the apparatus may be configured in a client installed on the electronic device or in a server, and may perform installation attribution on an application by performing an installation channel determining method. As shown in FIG. 4, the installation channel determining apparatus provided in this embodiment may include: a file obtaining module 401, a status determining module 402, and a first channel determining module 403, wherein
the file obtaining module 401 is configured to obtain a target program package file of a client;
the status determining module 402 is configured to determine target status information of a preset functional module set in the target program package file, wherein the preset functional module set contains at least one preset functional module, and the preset functional module set has different status information in program package files used by different installation channels; and
the first channel determining module 403 is configured to determine target installation channel information of the client based on the target status information.

According to the installation channel determining apparatus provided in this embodiment, the target program package file of the client is obtained by the file obtaining module; the target status information of the preset functional module set in the target program package file is determined by the status determining module, wherein the preset functional module set contains the at least one preset functional module, and the preset functional module set has different status information in the program package files used by different installation channels; and the target installation channel information of the client is determined based on the target status information by the first channel determining module. According to the technical solution in this embodiment, the installation channel of the application is indicated by the preset functional module, without obtaining a system operation permission on the device or using a third-party tool, so that the difficulty in determining the installation channel of the application can be reduced, and accuracy and controllability of a result of determining the installation channel of the application and security in a process of determining the installation channel of the application can be improved.

Optionally, the preset functional module is configured to be updated along with updating of a basic module in the program package file.

Optionally, the program package file is an Android app bundle (AAB) file, the basic module is a base module in the AAB file, and the preset functional module is a dynamic feature module in the AAB file.

Optionally, the target status information is used to indicate whether the target program package file contains the preset functional module.

Optionally, the target status information includes a module set code of the preset functional module set. The status determining module 402 includes: a result generating unit configured to perform functional module detection on the target program package file to generate a detection result, wherein the detection result is used to indicate module information of a first functional module and/or module information of a second functional module, the first functional module is a preset functional module contained in the target program package file, and the second functional module is a preset functional module not contained in the target program package file; and an encoding unit configured to encode the at least one preset functional module in a preset encoding manner based on the detection result to obtain the module set code of the preset functional module set.

Optionally, the encoding unit is specifically configured to: determine a status code of the first functional module as a first status code corresponding to the preset encoding manner, and determine a status code of the second functional module as a second status code corresponding to the preset encoding manner; arrange the status code of the at least one preset functional module according to a preset arrangement order corresponding to the preset encoding manner; and combine the arranged status code into one code as the module set code of the preset functional module set.

Optionally, the preset encoding manner includes a binary encoding manner.

Optionally, the first channel determining module 403 is specifically configured to:
retrieve installation channel information corresponding to the target status information from a preset correspondence table, use the installation channel information as target installation channel information of the client, and send the target installation channel information to a server, wherein the preset correspondence table is used to record correspondences between different status information and different installation channel information; or, send the target status information to the server, wherein the sent target status information is used by the server to determine the target installation channel information of the client.

The installation channel determining apparatus provided in the embodiments of the present disclosure can perform the installation channel determining method provided in any embodiment of the present disclosure, and has corresponding functional modules and beneficial effects for performing the installation channel determining method. For technical details not described in detail in this embodiment, reference may be made to the installation channel determining method provided in any embodiment of the present disclosure.

FIG. 5 is a block diagram of a structure of an installation channel determining apparatus according to an embodiment of the present disclosure. The apparatus may be implemented by software and/or hardware, and may be configured in an electronic device. Typically, the apparatus may be configured in a computer. For example, the apparatus may be configured in a server, and may perform installation attribution on an application by performing an installation channel determining method. As shown in FIG. 5, the installation channel determining apparatus provided in this embodiment may include: an information receiving module 501 and a second channel determining module 502, wherein
the information receiving module 501 is configured to receive target status information sent by a client, wherein the target status information is status information of a preset functional module set in a target program package file of the client, the preset functional module set contains at least one preset functional module, and the preset functional module set has different status information in program package files used by different installation channels; and
the second channel determining module 502 is configured to retrieve installation channel information corresponding to the target status information from a preset correspondence table, and use the installation channel information as target installation channel information of the client, wherein the preset correspondence table is used to record correspondences between different status information and different installation channel information.

According to the installation channel determining apparatus provided in this embodiment, the target status information sent by the client is received by the information receiving module, wherein the target status information is the status information of the preset functional module set in the target program package file of the client, the preset functional module set contains the at least one preset functional module, and the preset functional module set has different status information in the program package files used by different installation channels; and the installation channel information corresponding to the target status information is retrieved from the preset correspondence table and used as the target installation channel information of the client by the second channel determining module, wherein the preset correspondence table is used to record correspondences between different status information and different channel information. According to the technical solution in this embodiment, the installation channel of the application is indicated by the preset functional module, without obtaining a system operation permission on the device or using a third-party tool, so that the difficulty in determining the installation channel of the application can be reduced, and accuracy and controllability of a result of determining the installation channel of the application, and security in a process of determining the installation channel of the application can be improved.

The installation channel determining apparatus provided in the embodiments of the present disclosure can perform the installation channel determining method provided in any embodiment of the present disclosure, and has corresponding functional modules and beneficial effects for performing the installation channel determining method. For technical details not described in detail in this embodiment, reference may be made to the installation channel determining method provided in any embodiment of the present disclosure.

FIG. 6 is a schematic diagram of a structure of an electronic device (for example, a terminal device) 600 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processing unit or a graphics processing unit) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, wherein the computer program includes program code for performing the method shown in the flowchart. In such an embodiment, the computer program may be downloaded from a network through the communication apparatus 609 and installed, installed from the storage apparatus 608, or installed from the ROM 602. When the computer program is executed by the processing apparatus 601, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain a target program package file of a client; determine target status information of a preset functional module set in the target program package file, wherein the preset functional module set contains at least one preset functional module, and the preset functional module set has different status information in program package files used by different installation channels; and determine target installation channel information of the client based on the target status information; or
receive target status information sent by a client, wherein the target status information is status information of a preset functional module set in a target program package file of the client, the preset functional module set contains at least one preset functional module, and the preset functional module set has different status information in program package files used by different installation channels; and retrieve installation channel information corresponding to the target status information from a preset correspondence table, and use the installation channel information as target installation channel information of the client, wherein the preset correspondence table is used to record correspondences between different status information and different installation channel information.

Computer program code for performing operations of the present disclosure can be written in one or more programming languages or a combination thereof, wherein the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software program package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a module does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, Example 1 provides an installation channel determining method. The method includes:
obtaining a target program package file of a client;
determining target status information of a preset functional module set in the target program package file, wherein the preset functional module set contains at least one preset functional module, and the preset functional module set has different status information in program package files used by different installation channels; and
determining target installation channel information of the client based on the target status information.

According to one or more embodiments of the present disclosure, Example 2 is based on the method of Example 1, wherein the preset functional module is configured to be updated along with updating of a basic module in the program package file.

According to one or more embodiments of the present disclosure, Example 3 is based on the method of Example 2, wherein the program package file is an Android app bundle (AAB) file, the basic module is a base module in the AAB file, and the preset functional module is a dynamic feature module in the AAB file.

According to one or more embodiments of the present disclosure, Example 4 is based on the method of Example 1, wherein the target status information is used to indicate whether the target program package file contains the preset functional module.

According to one or more embodiments of the present disclosure, Example 5 is based on the method of Example 1, wherein the target status information includes a module set code of the preset functional module set, and determining the target status information of the preset functional module set in the target program package file includes:
performing functional module detection on the target program package file to generate a detection result, wherein the detection result is used to indicate module information of a first functional module and/or module information of a second functional module, the first functional module is a preset functional module contained in the target program package file, and the second functional module is a preset functional module not contained in the target program package file; and
encoding the at least one preset functional module in a preset encoding manner based on the detection result to obtain the module set code of the preset functional module set.

According to one or more embodiments of the present disclosure, Example 6 is based on the method of Example 5, wherein encoding the at least one preset functional module in the preset encoding manner based on the detection result to obtain the module set code of the preset functional module set includes:
determining a status code of the first functional module as a first status code corresponding to the preset encoding manner, and determining a status code of the second functional module as a second status code corresponding to the preset encoding manner;
arranging the status code of the at least one preset functional module according to a preset arrangement order corresponding to the preset encoding manner; and
combining the arranged status code into one code as the module set code of the preset functional module set.

According to one or more embodiments of the present disclosure, Example 7 is based on the method of Example 5, wherein the preset encoding manner includes a binary encoding manner.

According to one or more embodiments of the present disclosure, Example 8 is based on the method of any one of Examples 1 to 7, wherein determining target installation channel information of the client based on the target status information includes:
retrieving installation channel information corresponding to the target status information from a preset correspondence table, using the installation channel information as target installation channel information of the client, and sending the target installation channel information to a server, wherein the preset correspondence table is used to record correspondences between different status information and different installation channel information; or
sending the target status information to the server, wherein the sent target status information is used by the server to determine the target installation channel information of the client.

According to one or more embodiments of the present disclosure, Example 9 provides an installation channel determining method. The method includes:
receiving target status information sent by a client, wherein the target status information is status information of a preset functional module set in a target program package file of the client, the preset functional module set contains at least one preset functional module, and the preset functional module set has different status information in program package files used by different installation channels; and
retrieving installation channel information corresponding to the target status information from a preset correspondence table, and using the installation channel information as target installation channel information of the client, wherein the preset correspondence table is used to record correspondences between different status information and different installation channel information.

According to one or more embodiments of the present disclosure, Example 10 provides an installation channel determining apparatus. The apparatus includes:
a file obtaining module configured to obtain a target program package file of a client;
a status determining module configured to determine target status information of a preset functional module set in the target program package file, wherein the preset functional module set contains at least one preset functional module, and the preset functional module set has different status information in program package files used by different installation channels; and
a first channel determining module configured to determine target installation channel information of the client based on the target status information.

According to one or more embodiments of the present disclosure, Example 11 provides an installation channel determining apparatus. The apparatus includes:
an information receiving module configured to receive target status information sent by a client, wherein the target status information is status information of a preset functional module set in a target program package file of the client, the preset functional module set contains at least one preset functional module, and the preset functional module set has different status information in program package files used by different installation channels; and
a second channel determining module configured to retrieve installation channel information corresponding to the target status information from a preset correspondence table, and use the installation channel information as target installation channel information of the client, wherein the preset correspondence table is used to record correspondences between different status information and different installation channel information.

According to one or more embodiments of the present disclosure, Example 12 provides an electronic device. The electronic device includes:
one or more processors; and
a memory configured to store one or more programs, wherein
the one or more programs, when executed by the one or more processors, cause the one or more processors to implement the installation channel determining method according to any one of Examples 1 to 9.

According to one or more embodiments of the present disclosure, Example 13 provides a computer-readable storage medium having a computer program stored thereon, wherein the computer program, when executed by a processor, causes the installation channel determining method according to any one of Examples 1 to 9 to be implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. An installation channel determining method, comprising:
obtaining a target program package file of a client;
determining target status information of a preset functional module set in the target program package file, wherein the preset functional module set contains at least one preset functional module, and the preset functional module set has different status information in program package files used by different installation channels; and
determining target installation channel information of the client based on the target status information.

2. The method according to claim 1, wherein the preset functional module is configured to be updated along with updating of a basic module in the program package file.

3. The method according to claim 2, wherein the program package file is an Android app bundle (AAB) file, the basic module is a base module in the AAB file, and the preset functional module is a dynamic feature module in the AAB file.

4. The method according to claim 1, wherein the target status information is used to indicate whether the target program package file contains the preset functional module.

5. The method according to claim 1, wherein the target status information comprises a module set code of the preset functional module set, and determining the target status information of the preset functional module set in the target program package file comprises:
performing functional module detection on the target program package file to generate a detection result, wherein the detection result is used to indicate module information of a first functional module and/or module information of a second functional module, the first functional module is a preset functional module contained in the target program package file, and the second functional module is a preset functional module not contained in the target program package file; and
encoding the at least one preset functional module in a preset encoding manner based on the detection result to obtain the module set code of the preset functional module set.

6. The method according to claim 5, wherein encoding the at least one preset functional module in the preset encoding manner based on the detection result to obtain the module set code of the preset functional module set comprises:
determining a status code of the first functional module as a first status code corresponding to the preset encoding manner, and determining a status code of the second functional module as a second status code corresponding to the preset encoding manner;
arranging the status code of the at least one preset functional module according to a preset arrangement order corresponding to the preset encoding manner; and
combining the arranged status code into one code as the module set code of the preset functional module set.

7. The method according to claim 5, wherein the preset encoding manner comprises a binary encoding manner.

8. The method according to claim 1, wherein determining target installation channel information of the client based on the target status information comprises:
retrieving installation channel information corresponding to the target status information from a preset correspondence table, using the installation channel information as the target installation channel information of the client, and sending the target installation channel information to a server, wherein the preset correspondence table is used to record correspondences between different status information and different installation channel information; or
sending the target status information to the server, wherein the sent target status information is used by the server to determine the target installation channel information of the client.

9. An installation channel determining method, comprising:
receiving target status information sent by a client, wherein the target status information is status information of a preset functional module set in a target program package file of the client, the preset functional module set contains at least one preset functional module, and the preset functional module set has different status information in program package files used by different installation channels; and
retrieving installation channel information corresponding to the target status information from a preset correspondence table, and using the installation channel information as target installation channel information of the client, wherein the preset correspondence table is used to record correspondences between different status information and different installation channel information.

10. An electronic device, comprising:
at least one processor; and
a memory communicatively connected with the at least one processor, wherein
the memory stores a computer program executable by the at least one processor, and the computer program, when executed by the at least one processor, causes the at least one processor to perform an installation channel determining method comprising:
obtaining a target program package file of a client;
determining target status information of a preset functional module set in the target program package file, wherein the preset functional module set contains at least one preset functional module, and the preset functional module set has different status information in program package files used by different installation channels; and
determining target installation channel information of the client based on the target status information.

11. The electronic device according to claim 10, wherein the preset functional module is configured to be updated along with updating of a basic module in the program package file.

12. The electronic device according to claim 11, wherein the program package file is an Android app bundle (AAB) file, the basic module is a base module in the AAB file, and the preset functional module is a dynamic feature module in the AAB file.

13. The electronic device according to claim 10, wherein the target status information is used to indicate whether the target program package file contains the preset functional module.

14. The electronic device according to claim 10, wherein the target status information comprises a module set code of the preset functional module set, and determining the target status information of the preset functional module set in the target program package file comprises:
performing functional module detection on the target program package file to generate a detection result, wherein the detection result is used to indicate module information of a first functional module and/or module information of a second functional module, the first functional module is a preset functional module contained in the target program package file, and the second functional module is a preset functional module not contained in the target program package file; and
encoding the at least one preset functional module in a preset encoding manner based on the detection result to obtain the module set code of the preset functional module set.

15. The electronic device according to claim 14, wherein encoding the at least one preset functional module in the preset encoding manner based on the detection result to obtain the module set code of the preset functional module set comprises:
determining a status code of the first functional module as a first status code corresponding to the preset encoding manner, and determining a status code of the second functional module as a second status code corresponding to the preset encoding manner;
arranging the status code of the at least one preset functional module according to a preset arrangement order corresponding to the preset encoding manner; and
combining the arranged status code into one code as the module set code of the preset functional module set.

16. The electronic device according to claim 14, wherein the preset encoding manner comprises a binary encoding manner.

17. The electronic device according to claim 10, wherein determining target installation channel information of the client based on the target status information comprises:
retrieving installation channel information corresponding to the target status information from a preset correspondence table, using the installation channel information as the target installation channel information of the client, and sending the target installation channel information to a server, wherein the preset correspondence table is used to record correspondences between different status information and different installation channel information; or
sending the target status information to the server, wherein the sent target status information is used by the server to determine the target installation channel information of the client.
